(19) United States
(12) Patent Application Publication
(10) Pub. No.: US 2006/0251363 A1
(43) Pub. Date: Nov. 9, 2006

(54) LENS CAP

(75) Inventors: Shuji Shikano, Yaita-shi (JP); Takeshi Masujima, Yaita-shi (JP); Hideyuki Takeda, Yaita-shi (JP); Yoshio Tetsuka, Yaita-shi (JP)

Correspondence Address: DARBY & DARBY P.C., P. O. BOX 5257, NEW YORK, NY, 10150-5257, US

(73) Assignee: MORITEX CORPORATION, Tokyo (JP)

(21) Appl. No.: 11/379,400

(22) Filed: Apr. 20, 2006

(30) Foreign Application Priority Data
Apr. 21, 2005 (JP) 2005-123768

(51) Int. Cl. G02B 6/36

(52) U.S. Cl. 385/94

(57) ABSTRACT

A lens cap having a lens formed in the window at its top portion, used for a semiconductor laser, etc., using an aspherical lens instead of a spherical lens with large aberration. This invention proposes a lens cap having an aperture formed at its top portion, comprising a lens formed to fill the aperture in such a manner as to bulge on both sides of the aperture and further to extend beyond the circumferential edge defining the aperture along the top portion on both sides of the top portion or under the top portion only, wherein the outer circumference of the portion extended under the top portion contacts the lateral inside wall and top inside wall of the cap member. So, this invention can provide a cheap lens cap with high performance.

### INCORPORATION BY REFERENCE

The present application claims priority under 35 U.S.C. §119 to Japanese Patent Application No. 2005-123768 filed on Apr. 21, 2005. The content of the application is incorporated herein by reference in its entirety.

### FIELD OF THE INVENTION

The present invention relates to a lens cap used for a semiconductor laser, etc.

### BACKGROUND OF THE INVENTION

Since a semiconductor laser is deteriorated because of the influence of oxygen and water in air, it is usually contained in a highly airtight package and kept in nitrogen atmosphere, and the output light is delivered through a glass window installed in the top portion of a lens cap used as the package.

On the other hand, in the semiconductor laser application field such as optical communication, a lens with a focal distance of about 1 mm is placed very close to a semiconductor laser, for efficiently coupling the output light of the semiconductor laser with an optical fiber.

To satisfy these two requirements, produced is a semiconductor laser using a cap with a lens installed in the window provided at its top portion, i.e., a so-called lens cap as a component of its package.

Conventional methods for producing such a lens cap include the following methods.

In patent document 1, JP6-201962A, a deep drawing press is used to produce a hat-shaped cap member having a flange-like flat portion formed at the bottom of its cylindrical portion and a lens mounting aperture formed in its top portion, and a spherical lens is mounted in the lens mounting aperture and bonded using frit glass as an adhesive, for being held.

In patent document 2, JP5-119241A for stably and reliably bonding and holding a cylindrical lens in the lens mounting aperture at the top of a cap member, a bent-back cylindrical portion is formed at the central portion of a mounting plate portion formed at the top, concentrically with the outer cylindrical portion of the cap. This cap member can be produced by press molding of low production cost, not by cutting work of high production cost.

The method described in the aforesaid patent document 1 is intended to bond a spherical lens to a cap member. However, since a spherical lens has large aberration, the rate of the light capable of falling on the optical fiber based on the quantity of the output light of the semiconductor laser, that is, the coupling efficiency is as low as about 20%. For this reason, to enhance the coupling efficiency, an aspherical lens having small aberration is used. However, in the case where an aspherical lens is bonded to a cap member, the lens must be bonded generally with the lens inclination kept at 0.1 degree or less, unlike a spherical lens. So, the method of the patent document 1 cannot be used.

Therefore, as described as a conventional technique in the patent document 2, the cap member is produced as a highly accurate cut metallic part, and the aspherical lens is bonded to the inside of the lens mounting aperture using frit glass. However, in this method, the cut part is expensive.

In the invention described in the aforesaid patent document 2, a part produced by a deep drawing press is used instead of the conventional cut metallic part, with an intention to solve the problem of cost. However, even though the part is made by deep drawing, the shape is complicated and the mold is also complicated to raise the cost to a level higher than the costs of the general conventional parts produced by deep drawing.

The object of the present invention is to solve the conventional problems as described above and to improve the bonding strength and airtightness of the lens.

### SUMMARY OF THE INVENTION

To solve the above problems, this invention proposes a lens cap that has a cap member with an aperture formed in its top portion, comprising a lens molded to fill the aperture in such a manner as to bulge on both sides of the aperture, and further to extend beyond the circumferential edge defining the aperture along the top portion on both sides of the top portion.

Furthermore, this invention proposes a lens cap that has a cap member with an aperture formed in its top portion, comprising a lens molded to fill the aperture in such a manner as to bulge on both sides of the aperture, and further to extend beyond the circumferential edge defining the aperture along the top portion on both sides of the top portion, wherein the extended portion of the lens under the top portion of the cap member contacts the lateral inside wall and top inside wall of the cap member.

Still furthermore, this invention proposes a lens cap that has a cap member with an aperture formed in its top portion, comprising a lens molded to fill the aperture in such a manner as to bulge on both sides of the aperture, and further to extend beyond the circumferential edge defining the aperture along the top portion under the top portion only.

Still furthermore, this invention proposes a lens cap that has a cap member with an aperture formed in its top portion, comprising a lens molded to fill the aperture in such a manner as to bulge on both sides of the aperture, and further to extend beyond the circumferential edge defining the aperture along the top portion under the top portion only, wherein the extended portion of the lens under the top portion of the cap member contacts the lateral inside wall and top inside wall of the cap member.

Still furthermore, this invention proposes a lens cap of the above constitution, wherein the aperture of the cap member has such a diameter as to allow the aperture to function as the pupil of the lens.

Still furthermore, this invention proposes a lens cap of the above constitution, wherein the cap member is formed by press molding.

Still furthermore, this invention proposes a lens cap of the above constitution, wherein the lens is produced by placing the top portion of the cap member and a lens preform in the space between the upper mold member and the lower mold member of a mold, and molding the lens preform by hot working.

Still furthermore, this invention proposes a lens cap of the above constitution, wherein the lens preform is spherical and placed in the aperture of the top portion.

Still furthermore, this invention proposes a lens cap of the above constitution, wherein the lens preform is formed like a flat plate and placed between the cap member and the lower mold member.

In this invention, the lens is molded to fill the aperture in such a manner as to bulge on both sides of the aperture, and further to extend beyond the circumferential edge defining the aperture along the top portion on both sides of the top portion or under the top portion only. So, when the lens is molded by hot working or the like, the reference plane of the cap member can be positioned highly accurately for the lens to be molded.

Therefore, even if a press-molded article not complicated in shape and not high in working accuracy is used as the cap member, a lens with an adequate shape, i.e., an aspherical lens can be highly accurately positioned and formed in reference to the reference plane of the cap member.

As shown in the drawings, the glass forming the lens is formed not only to fill the aperture of the cap member in such a manner as to bulge on both sides of the aperture but also to extend beyond the circumferential edge defining the aperture along the top portion, the contact area with the cap member is large, and the lens cap obtained can have excellent airtightness.

Especially if the extended portion of the lens under the top portion of the cap member contacts the lateral inside wall and top inside wall of the cap member, the contact area with the cap member is very large to increase the so-called caulking effect, for improving airtightness, and the lens cap obtained can also have higher bonding strength. Furthermore, since the caulking effect is large, the difference between the thermal expansion coefficient of the cap member and that of the glass can also be larger, to expand the selection range of materials available for them.

Moreover, the extended portion of the lens formed beyond the circumferential edge defining the aperture along the top portion does not actually function as a lens. So, this portion is not dimensionally limited, and therefore can absorb the extra portion of the lens preform. Hence, the tolerance in the volume of the lens preform can be made large to contribute to cost reduction.

If the aperture of the cap member is used as the pupil of the lens, the performance of the lens can be improved.

In the case where a lens preform formed like a flat plate is used, the cost can be reduced compared with the case of using a spherical lens preform, since it is only required to mirror-finish the flat surfaces only.

### BRIEF DESCRIPTION OF THE DRAWINGS

FIG. 1 is a sectional view showing an embodiment of the lens cap of this invention.

FIG. 2 is a sectional view showing an embodiment of the apparatus for producing the lens cap of FIG. 1, in the state before molding the lens.

FIG. 3 is a sectional view showing an embodiment of the apparatus for producing the lens cap of FIG. 1, in the state after molding the lens.

FIG. 4 is a partial sectional view showing an example of the semiconductor laser module produced using the lens cap of FIG. 1.

FIG. 5 is a sectional view showing another embodiment of the lens cap of this invention.

FIG. 6 is a sectional view showing an embodiment of the apparatus for producing the lens cap of FIG. 5, in the state before molding the lens.

FIG. 7 is a sectional view showing an embodiment of the apparatus for producing the lens cap of FIG. 5, in the state after molding the lens.

FIG. 8 is a partial sectional view showing an example of the semiconductor laser module produced using the lens cap of FIG. 5.

FIG. 9 is a sectional view showing a further embodiment of the lens cap of this invention.

FIG. 10 is a sectional view showing a fourth embodiment of the lens cap of this invention.

FIG. 11 is a sectional view showing an embodiment of the lens cap of this invention.

FIG. 12 is a sectional view showing another embodiment of the lens cap of this invention.

FIG. 13 is a sectional view showing an embodiment of the apparatus for producing the lens cap of FIG. 12, in the state before molding the lens.

FIG. 14 is a sectional view showing an embodiment of the apparatus for producing the lens cap of FIG. 12, in the state after molding the lens.

### PREFERRED EMBODIMENT OF THE INVENTION

This invention is explained below in detail in reference to the drawings showing embodiments.

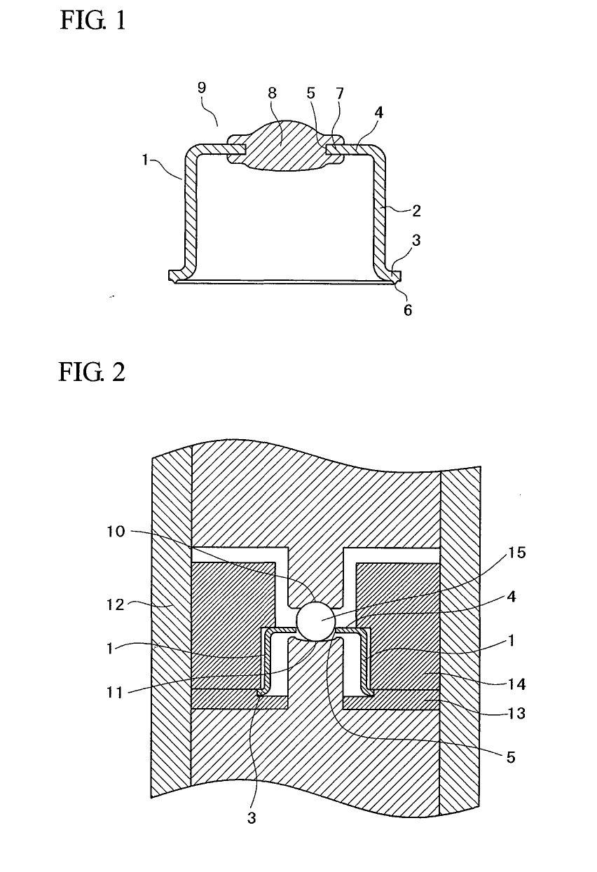

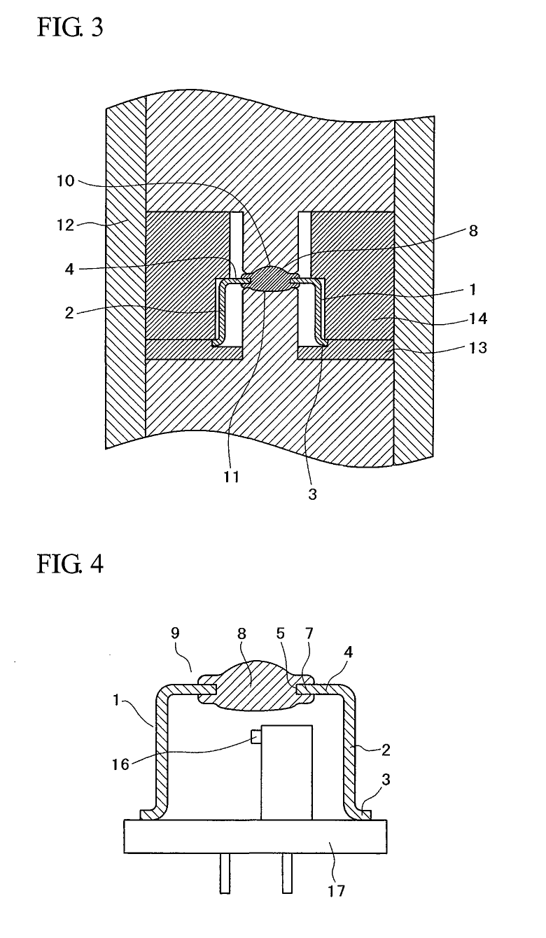

FIGS. 1 to 4 show an embodiment of this invention. FIG. 1 is a sectional view showing a lens cap. FIGS. 2 and 3 show an apparatus for producing the lens cap of FIG. 1, and are respectively sectional views showing the state before molding the lens and the state after molding the lens. FIG. 4 is a partial sectional view showing a semiconductor laser module produced by using the lens cap of FIG. 1.

In these drawings, symbol 1 denotes a cap member, and the cap member 1 has the same form as that of the conventional hat-shaped press-molded metallic article. That is, in the cap member 1, a flange-like flat portion 3 is protruded around a cylindrical portion 2 at the bottom, and furthermore, a flat top portion 4 is formed at the top. The top portion 4 has an aperture 5 formed in it, and the bottom face of the flange-like flat portion 3 has a projection 6 formed for welding. The cap member 1 can be produced by press molding at low cost.

As shown in FIG. 1, this embodiment is a lens cap 9 in which a lens 8 is formed to fill the aperture 5 of the cap member 1 in such as a manner as to bulge on both sides of the aperture 5, and further to extend beyond the circumferential edge 7 defining the aperture 5 along the top portion 4 on both sides of the top portion 4. This lens cap 9 can be easily produced, for example, by the production apparatus shown in FIG. 2 and 3.

In FIGS. 2 and 3, symbol 10 denotes an upper mold member for the lens; 11, a lower mold member for the lens; and 12, a cylindrical mold holder. The upper mold member 10 can ascend and descend along the cylindrical mold holder 12. The cap member 1 is held at the flange-like flat portion 3 and at the top portion 4 by means of holding members 13 and 14, and held highly accurately and reliably at a reference position for the lens to be molded.

At first, as shown in FIG. 2, a lens preform, a spherical lens preform 15 in this case, is placed in the space between the upper mold member 10 and the lower mold member 11, and if the upper mold member 10 is lowered in this state with predetermined heating, to hot-work the glass of the lens preform 15 by the upper mold member 10 and the lower mold member 11, a predetermined lens 8 is formed by the upper mold member 10 and the lower mold member 11, to fill the aperture 5 in such a manner as to bulge on both sides of the aperture 5 as shown in FIG. 3. Simultaneously the extra portion of the lens preform 15 is pressed out in the direction perpendicular to the upper mold member 10 and the lower mold member 11, to extend beyond the circumferential edge defining the aperture 5 along the top portion on both sides of the top portion. Thus, the lens cap 9 shown in FIG. 1 can be produced.

During the hot working, since the top portion 4 of the cap member 1 does not contact the upper mold member 10 or the lower mold member 11, the above-mentioned accurate positional holding can be maintained. As a result, the cap member 1 can be reliably held at the reference position for the lens to be molded, while the lens 8 is molded. Therefore, in this invention, while the lens 8 is molded, the lens 8 can be highly accurately positioned in reference to the reference plane of the cap member 1, for example, in reference to the flange-like flat portion 3.

Therefore, even if a press-molded article with low working accuracy is used as the cap member 1, the lens cap 9 obtained can have an adequately shaped lens 8 highly accurately positioned in reference to the reference plane of the cap member 1.

In this case, the glass forming the lens 8 is formed not only to fill the aperture 5 of the cap member 1 in such a manner as to bulge on both sides of the aperture, but also to extend beyond the circumferential edge 7 defining the aperture 5, the contact area with the cap member 1 is large, and the lens cap 9 obtained can have excellent airtightness. Furthermore, since the extended lens portion formed beyond the circumferential edge 7 defining the aperture 5 does not actually function as a lens, the portion is not dimensionally limited. Therefore, since the lens portion can absorb the extra portion of the lens preform 15, the tolerance in the volume of the lens preform 15 can be made large to contribute to cost reduction.

The lens cap 9 produced as described above can be positioned as predetermined in reference to a stem 17 holding a semiconductor laser 16, and the flange-like flat portion 3 can be fixed by welding to the upper surface of the stem 17, to produce a semiconductor laser module as an airtight package. The output light of the semiconductor laser 16 can be taken out highly efficiently through the accurately positioned lens 8 such as an aspherical lens.

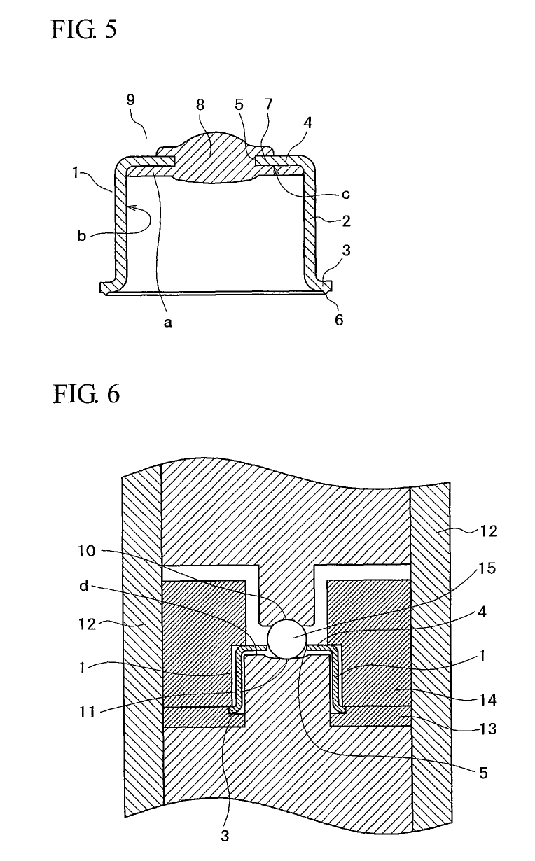

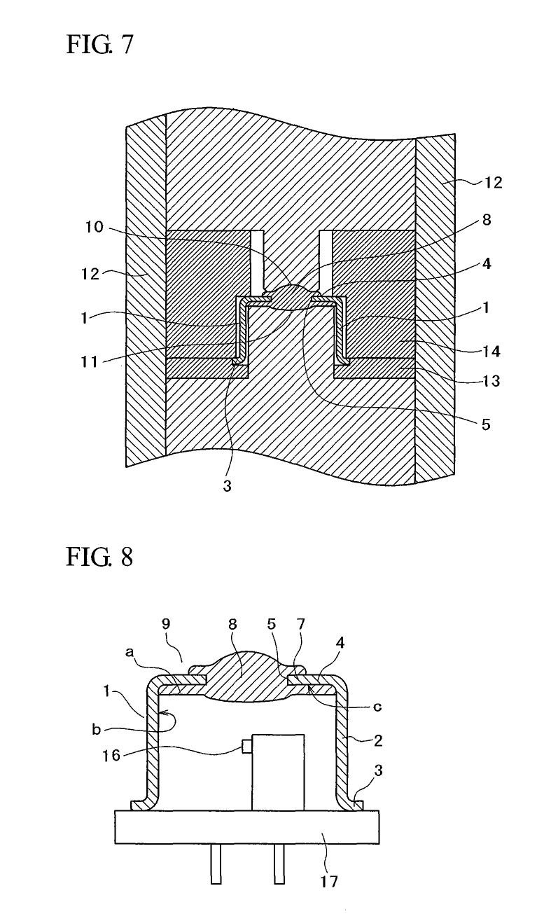

FIGS. 5 to 8 show another embodiment of this invention. FIG. 5 is a sectional view showing a lens cap. FIGS. 6 and 7 show the apparatus for producing the lens cap of FIG. 5 and are sectional views respectively showing the state before molding the lens and the state after molding the lens. FIG. 8 is a partial sectional view showing a semiconductor laser module produced using the lens cap of FIG. 5.

As shown in FIG. 5, in the lens cap of this embodiment, the lens 8 is formed to fill the aperture 5 of the cap member 1 in such a manner as to bulge on both sides of the aperture 5, and further to extend beyond the circumferential edge 7 defining the aperture 5 along the top portion 4 on both sides of the top portion 4 as in the previous embodiment. However, in this second embodiment, the extended portion a of the lens 8 under the top portion 4 of the cap member 1 contacts the lateral inside wall b and top inside wall c of the cap member 1. The other components of this embodiment are the same as those of the previous embodiment. So, in FIGS. 5 to 8, the same symbols are used for denoting the same components, to avoid double explanation.

The lens cap 9 of the present embodiment can be easily produced by the production apparatus shown in FIGS. 6 and 7. In this production apparatus, compared with the apparatus of FIGS. 2 and 3, the lower mold member 11 has a larger diameter, and a wide flat portion d is formed around the concave surface corresponding to the convex surface of the lens 8. The end of the flat portion d is positioned near the lateral inside wall b of the cap member 1.

In the above-mentioned constitution, as shown in FIG. 6, the lens preform 15 is placed in the space between the upper mold member 10 and the lower mold member 11, and the upper mold member 10 is lowered in this state with predetermined heating, to hot-work the glass of the lens preform 15 by the upper mold member 10 and the lower mold member 11. As a result, as shown in FIG. 7, the lens 8 is formed by the upper mold member 10 and the lower mold member 11, to fill the aperture 5 in such a manner as to bulge on both sides of the aperture 5. Simultaneously the remaining portion of the lens preform 15 moves in the direction perpendicular the upper mold member 10 and the lower mold member 11, to extend beyond the circumferential edge defining the aperture 5 along the top portion on both sides of the top portion. The extended portion a of the lens 8 under the top portion 4 of the cap member 1 fills the space between the top portion 4 of the cap member 1 and the lower mold member 11, and the outer circumference of the extended portion a contacts the lateral inside wall b of the cap member 1. Thus, the lens cap 9 shown in FIG. 5 can be produced.

This embodiment has the features mentioned for the previous embodiment. In addition, the glass forming the lens 8 is formed not only to fill the aperture 5 of the cap member 1 in such a manner as to bulge on both sides of the aperture 5, but also to extend beyond the circumferential edge 7 defining the aperture 5. Especially the extended portion a of the lens under the top portion 4 of the cap member 1 contacts the lateral inside wall b and top inside wall c of the cap member 1. So, the contact area with the cap member 1 is very large to assure excellent airtightness and the lens cap 9 obtained can also have excellent bonding strength.

Meanwhile, since the extended portion of the lens beyond the circumferential edge 7 defining the aperture 5 does not actually function as a lens, it is not dimensionally limited if the outer circumference of the extended portion a under the top portion 4 contacts the lateral inside wall of the cap member 1. Therefore, since the portion a can absorb the extra portion of the lens preform 15, the tolerance in the volume of the lens preform 15 can be made large to contribute to cost reduction.

The lens cap 9 produced as described above can be positioned as predetermined in reference to the stem 17 holding the semiconductor laser 16, and the flange-like flat portion 3 can be fixed by welding to the upper surface of the stem 17 as shown in FIG. 8, to produce a semiconductor laser module as an airtight package. The output light of the semiconductor laser 16 can be taken out highly efficiently through the accurately positioned lens 8 such as an aspherical lens.

Particular examples of the semiconductor laser modules obtained by using the lens caps 9 of the above embodiments are as follows.

Lens glass: SF66

Cap member: 50% NiFe (or Kovar)

Focal distance: 0.9 mm

NA of semiconductor laser: 0.5

Coupling ratio: 4 times

Transmitted wavefront aberration: 0.03 wavelength

Coupling efficiency with a semiconductor laser NA of 0.4 and with an optical fiber NA of 0.1: About 80%

In the above semiconductor laser modules, in view of lens performance, especially important are the forms of the two lens surfaces and the misalignment of the two lens surfaces from the optical axis (decenter). Furthermore, in the installation for the semiconductor laser, important are the distance (WD) between the flange-like flat portion 3 as the reference plane of the lens cap 9 and the lens 8, and the tilt against the flange-like flat portion 3 (element tilt). When the lens caps of FIGS. 1 and 5 were produced using the production apparatuses of FIGS. 2 and 3 and FIGS. 6 and 7, the following accuracies could be achieved.

Decenter: 5 microns

WD: 20 microns

Element tilt: 0.5 degree or less

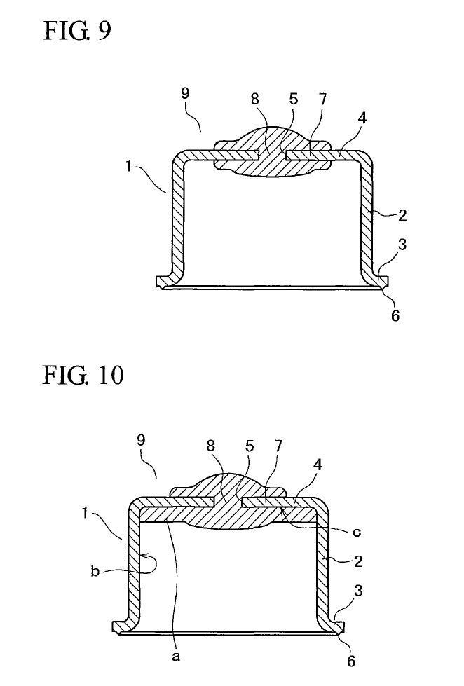

FIGS. 9 and 10 show additional embodiments of the lens cap 9 of this invention.

In each of these embodiments, the diameter of the aperture 5 of the cap member 1 is kept smaller than that of the first and second embodiments, and the other components are the same as those of FIGS. 1 and 5. So, the same symbols are used to denote the corresponding components, for avoiding double explanation.

In each of the other embodiments, the aperture 5 of the cap member 1 is made smaller to function as the pupil of the lens 8, for improving the performance of the lens 8. That is, the aperture 5 is made smaller to function as a pupil, for intercepting the rays of light on the outer circumference of the lens, which give the problem of spherical aberration. So, though the image becomes dark, fuzziness can be eliminated. Therefore, for example, in the coupling between the semiconductor laser 16 and an optical fiber (not shown in the drawings), the diameter of the pupil, i.e., the diameter of the aperture 5 can be optimized to enhance the coupling efficiency.

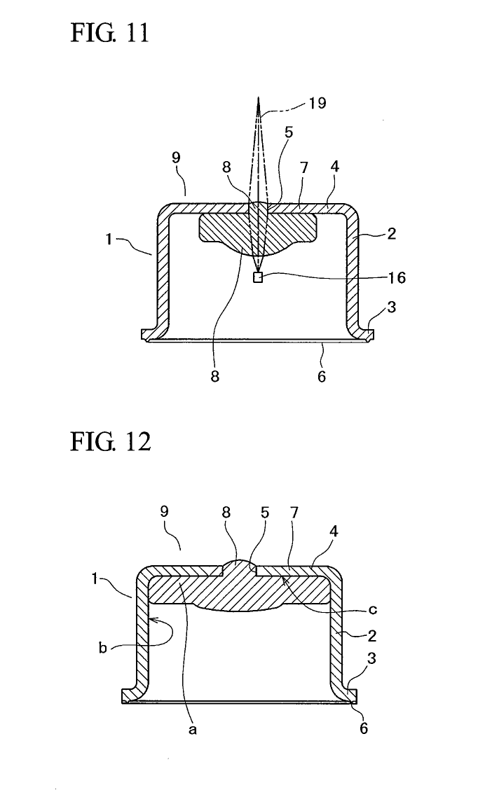

FIGS. 11 and 12 show further embodiments of the lens cap 9 of this invention. In each of the embodiments, the diameter of the aperture 5 of the cap member 1 is made small as in the previous embodiments, and the lens 8 is formed to fill the aperture 5 in such a manner as to bulge on both sides of the aperture 5 and further to extend beyond the circumferential edge 7 defining the aperture 5 along the top portion 4 under the top portion 4 only.

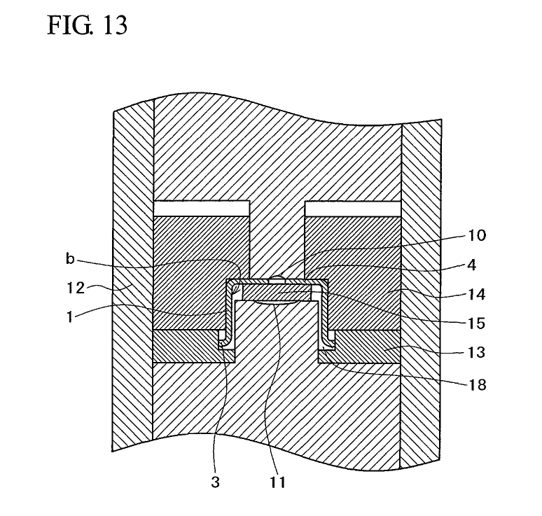

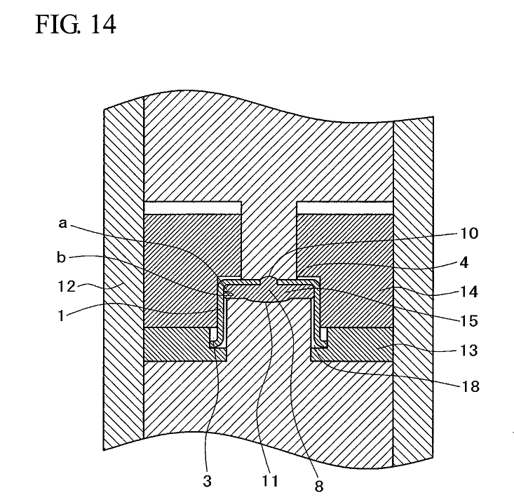

FIGS. 11 and 12 are sectional views showing the embodiments of the lens cap 9, and FIGS. 13 and 14 are sectional views showing the apparatuses used for molding the fifth and sixth embodiments of the lens cap 9. In FIG. 11, symbol 19 denotes an optical path.

Each of the production apparatuses consists of the same components as those of FIGS. 2, 3, 6 and 7, generally, the upper mold member 10 and the lower mold member 11 for the lens, and the cylindrical mold holder 12 for guiding the upper mold member 10 in the vertical direction. Around the lower mold member 11, a holding member 13 for holding the lower portion of the cap member 1 is installed, and on it, a holding member 14 for holding the upper portion of the cap member 1 is installed.

In each of the production apparatuses, when the lens is molded, at first a lens preform 15 shaped like a flat plate is placed on the upper surface of the lower mold member 11, and then the cap member 1 is placed on the lens preform 15 placed on the lower mold member 11. Subsequently, the holding member 14 fitted in the cylindrical mold holder 12 is fitted around the cap member 1.

The inner diameter of the holding member 14 is slightly larger than the outer diameter of the cylindrical portion 2 of the cap member 1. So, the cap member 1 is held in a predetermined position in the direction perpendicular to the upper mold member 10 and the lower mold member 11 by the holding member 14. The upper mold member 10 fitted in the holding member 14 is kept in contact with the top portion of the cap member 1.

In this state, as can be seen from FIG. 13, the cap member 1 is held at a position by a predetermined distance above the lower mold member 11 owing to the lens preform 15, and to allow this holding, the holding member 13 has a space 18 formed to allow the flange-like flat portion 3 of the cap member 1 to move vertically.

In this state, if the upper mold member 10 is lowered with predetermined heating, to hot-work the glass of the lens preform 15 by the upper mold member 10 and the lower mold member 11, the predetermined lens 8 is formed by the upper mold member 10 and the lower mold member 11, to fill the aperture 5 in such a manner as to bulge on both sides of the aperture 5, and the extra portion of the lens preform 15 is pressed out in the direction perpendicular to the lower mold member 11, to extend beyond the circumferential edge defining the aperture 5 along the top portion 4 under the top portion 4 as shown in FIG. 14, to produce the lens cap 9 shown in FIG. 12.

In the above embodiments, where a lens perform formed like a flat plate is used, the cost can be reduced compared with the case of using a spherical lens perform, since it is only required to mirror-finish the flat surfaces only.

If the shape of the lower mold member 11 of this production apparatus is adjusted, the lens cap 9 shown in FIG. 11 can be produced.

In each the embodiments explained above, the aperture 5 of the cap member 1 is made smaller as in the previous two embodiments, to function as the pupil of the lens 8 as shown by the optical path 19 in FIG. 11, for enhancing the performance of the lens 8. Furthermore, since no portion of the lens 8 is formed above the top portion 4 of the cap member 1, for example, the welding work for welding a support member of the optical fiber or a support member of a second lens or the like onto the top portion 4 is little inconvenienced.

The particular examples of the lens caps 9 of the present embodiments are as follows.

Lens glass: SF66

Radius of first surface: 1 mm

Radius of second surface: −0.5 mm

Thickness at the center of lens: 0.8 mm

Diameter of pupil (aperture 5): 0.4 mm

Furthermore, when the diameter of the pupil was changed in these embodiments, the coupling efficiency between the semiconductor laser and the optical fiber changed as shown below. In this case, the NA of the semiconductor laser was 0.4 and the NA of the optical fibers was 0.1.

| Pupil diameter (mm) | Coupling efficiency (%) |
|---|---|
| 0.3 | 31 |
| 0.4 | 42 |
| 0.5 | 32 |

Since this invention is as described above, it has various advantages as described below, and since it can provide a cheap lens cap with high performance, it is highly industrially applicable.

Since a press-molded article can be used as the cap member, the cost can be reduced compared with the case of using a cut article.

The cap member is not required to have a special shape, and a general hat-shaped press-molded article can be used. So, the cost can be reduced compared with the case of using a specially shaped article.

When the lens is molded by hot working or the like, the reference plane of the cap member can be positioned highly accurately for the lens to be molded. So, even if a press-molded article not so high in working accuracy is used, an adequately formed lens, i.e., an aspherical lens can be highly accurately positioned and formed in reference to the reference plane of the cap member.

If the aperture of the cap member is used as the pupil of the lens, the performance of the lens can be improved, and the coupling efficiency between the semiconductor laser and the optical fiber can be enhanced.

The glass forming the lens can be formed not only to fill the aperture of the cap member in such a manner as to bulge on both sides of the aperture, but also to extend beyond the circumferential edge defining the aperture along the top portion of the cap member on both sides of the top portion, or under the top portion only. Especially if the portion extended under the top portion is further extended to contact the lateral inside wall and top inside wall of the cap member, the contact area with the cap member becomes very large, to assure excellent airtightness due to the so-called caulking effect. The lens cap obtained can also have excellent bonding strength.

Moreover, since the caulking effect is large, the difference between the thermal expansion coefficient of the cap member 1 and that of the glass can be made large to expand the range of materials available for them.

Since the extra portion of the lens preform can be absorbed, the tolerance in the volume of the lens preform can be made large to contribute to cost reduction.

In the case where a lens preform formed like a flat plate is used, the cost can be reduced compared with the case of using a spherical lens preform, since it is only required to mirror-finished the flat surfaces only.

What is claimed is:

1. A lens cap that has a cap member with an aperture formed in its top portion, comprising a lens molded to fill the aperture in such a manner as to bulge on both sides of the aperture, and further to extend beyond the circumferential edge defining the aperture along the top portion on both sides of the top portion.

2. A lens cap according to claim 1, wherein the extended portion of the lens under the top portion of the cap member contacts the lateral inside wall and top inside wall of the cap member.

3. A lens cap that has a cap member with an aperture formed in its top portion, comprising a lens molded to fill the aperture in such a manner as to bulge on both sides of the aperture, and further to extend beyond the circumferential edge defining the aperture along the top portion under the top portion only

4. A lens cap according to claim 3, wherein the extended portion of the lens under the top portion of the cap member contacts the lateral inside wall and top inside wall of the cap member.

5. A lens cap, according to claim 1, wherein the aperture of the cap member has such a diameter as to allow the aperture to function as the pupil of the lens.

6. A lens cap, according to claim 1, wherein the cap member is formed by press molding.

7. A method of forming a lens cap comprising the steps of:
placing a top portion of the cap member and a lens preform in a space between an upper mold member and a lower mold member of a mold, and
molding the lens preform by hot working.

8. A method, according to claim 7, wherein the lens preform is spherical and further comprising the step of placing the lens perform in the aperture of the top portion.

9. A method, according to claim 7, further comprising the steps of:
forming the lens preform like a flat plate and
placing the lens perform between the cap member and the lower mold member.

10. A lens cap, according to claim 3, wherein the aperture of the cap member has such a diameter as to allow the aperture to function as the pupil of the lens.

11. A lens cap, according to claim 3, wherein the cap member is formed by press molding.
